(19) United States
(12) Patent Application Publication
(10) Pub. No.: US 2007/0067513 A1
(43) Pub. Date: Mar. 22, 2007

(54) Method for a control device to command another control device

(76) Inventors: Shih-Chieh Liu, Jhubei City (TW); Chia-Hsin Chen, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/522,899

(22) Filed: Sep. 19, 2006

(30) Foreign Application Priority Data
Sep. 22, 2005 (TW) 094132901

(51) Int. Cl. G06F 13/38

(52) U.S. Cl. 710/62

(57) ABSTRACT

In a method for a control device to command another control device, the first control device writes commands to a predetermined area in a storage unit, and the second control device reads the commands from the predetermined area and executes therewith. Therefore, the complexity of the control devices is simplified and the burden of the control devices designer is reduced.

### FIELD OF THE INVENTION

The present invention is related generally to a control method and, more particularly, to a method for a control device to command another control device.

### BACKGROUND OF THE INVENTION

Currently, a powerful electronic device may use two or more control devices such as central processing unit (CPU), microprocessor, microcontroller, and the like. The way for communications between two control devices, for example a CPU 10 and a microcontroller 12 as shown in FIG. 1, comprises transmitting commands mutually by a path A, for example USB or other bus. In more detail, the CPU 10 sends its commands to the microcontroller 12 through the path A for the latter to execute, and likewise, the controller 12 sends its commands to the CPU 10 through the path A to carry out.

However, such communications have some requirements, for example, a compatible communication protocol established between the communicating devices. For a control device adaptive to various other control devices it may communicate with in different applications, therefore, it is required several versions developed for the control device. This limitation results in the design of a control device more complicated and constrains the application of a control device.

### SUMMARY OF THE INVENTION

Accordingly, an object of the present invention is to provide a method for a control device to command another control device, and specifically, the first control device will write commands into a predetermined area in a storage unit for the second control device to read and execute.

### BRIEF DESCRIPTION OF DRAWINGS

The above and other objects, features and advantages of the present invention will become apparent to those skilled in the art upon consideration of the following description of the preferred embodiment of the present invention taken in conjunction with the accompanying drawings, in which:

FIG. 1 shows the communications between a CPU and a microcontroller by mutually transmitting commands through a path;

FIG. 2 shows a diagram of illustrating the control between two control devices accomplished by a predetermined area according to the present invention;

FIG. 3 shows a configuration of the predetermined area used by control devices according to the present invention; and

FIG. 4 shows a flowchart of a control device to execute commands according to the present invention.

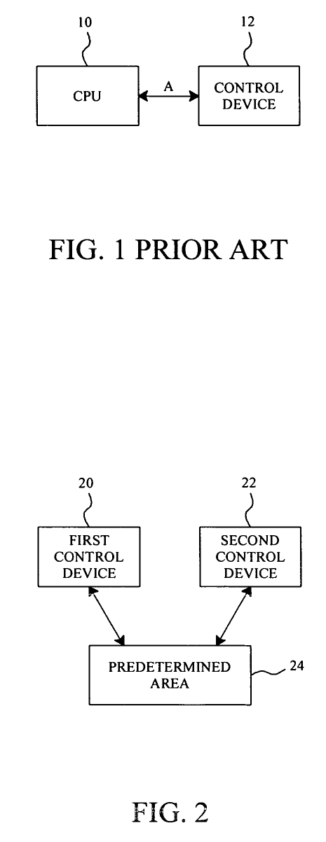

### DETAILED DESCRIPTION OF THE INVENTION

In a simplified functional block diagram as shown in FIG. 2, according to the present invention, two control devices 20 and 22 may transmit their respective commands to control the other one through a predetermined area 24. For example, when the first control device 20 desires to control the second control device 22, it doesn't send its commands directly to the second control device 22, but writes the commands into the predetermined area 24, and then the second control device 22 reads the commands from the predetermined area 24 and executes therewith. On the contrary, to control the first control device 20 by the second control device 22, the latter writes its commands into the predetermined area 24 for the first control device 20 to read therefrom and execute therewith.

In this embodiment, the predetermined area 24 is in a storage unit (not shown in FIG. 2) outside the control devices 20 and 22, and it may be a DRAM, SRAM, EPROM, EEPROM, flash memory, or other type of memories. In different embodiments, either or both of the control devices 20 and 22 can be microcontroller, microprocessor, CPU or other type of control devices.

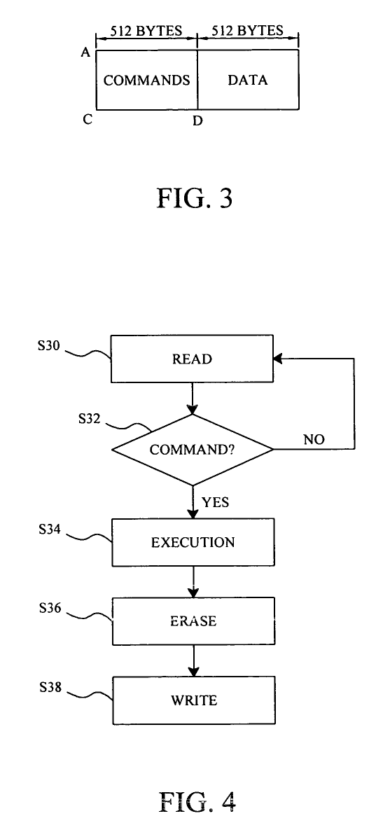

FIG. 3 shows a configuration of the predetermined area 24, in which the former 512 bytes of the predetermined area 24 are used to store commands and the latter 512 bytes is used to store data related to the commands stored in the former 512 bytes. The commands issued by the first control device 20 or the second control device 22 are written into the predetermined area 24 beginning from the address C and data are written beginning from the address D.

The addresses C and D for the beginning of the commands and data to store in the predetermined area 24 are predefined according to the agreement between the control devices 20 and 22, and therefore either one of the control devices 20 and 22 will know from where to write and read commands and data in the predetermined area 24.

In some embodiments, commands and data are written into the predetermined area 24 at once. For example, the first control device 20 issues a signal of 1024 bytes, in which the first 512 bytes are commands and the others (512 bytes) are data, and with the definition shown in FIG. 3, the second control device 22 knows that the command begins from the address C and the data begins from the address D.

In other embodiments, the volume of the predetermined area 24 and the volume to store commands or data can be adjusted based on specific applications.

FIG. 4 shows how a control device operates according to the present invention. With the same case of FIGS. 2 and 3, it will be illustrated the process of the first control device 20 to command the second control device 22.

In this flowchart, the second control device 22 actively reads the content of the predetermined area 24 in step S30, and judges whether or not any command is read in step S32. If no command is read, it will go back to the step S30, otherwise go to step S34 to execute the command it reads in the step 30. After completing the execution, the second control device 22 further erases the predetermined area 24 in step S36, and then writes the execution result, for example success or failure, into the predetermined area 24 in step S38. The first control device 20 may realize the execution result from the predetermined area 24.

In this embodiment, the first control device 20 may realize the execution result by reading the content of the predetermined area 24. In alternative embodiments, however, the second control device 22 may write the execution result into other area in the same storage unit or other storage unit.

In one embodiment, the content of the predetermined area 24 written by the second control device 22 may include a flag to indicate the written content is a command or an execution result.

The process that the second control device 22 commands the first control device 20 is similar to the above description, only with the role changing of the command sender and executer.

According to the present invention, two control devices send command and report the execution result by writing into/reading from a predetermined area in a storage unit, without considering any communication protocol therebetween as in the conventional method, and therefore one control device can collocate with various control devices with nearly no limitations. In other words, the design complexity of a control device is reduced and it is also helpful in standardizing the communication method between two control devices. The present invention can be applied in personal digital assistant (PDA), mobile phone or other electronic devices having two control devices.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method for a first control device to command a second control device, comprising the steps of:
writing a command into a predetermined area in a storage unit by the first control device;
reading the command from the predetermined area by the second control device; and
executing the command by the second control device.

2. The method according to claim 1, further comprising the step of erasing the predetermined area by the second control device after the step of reading the command from the predetermined area by the second control device.

3. The method according to claim 2, further comprising the step of writing an execution result into the predetermined area by the second control device.

4. The method according to claim 1, further comprising the step of writing an execution result by the second control device into a second area other than the predetermined area in the storage unit.

5. The method according to claim 3, further comprising the step of setting a flag for indicating the content of the predetermined area is the execution result or another command.

6. The method according to claim 1, wherein the first control device is selected from the group consisting of microcontroller, microprocessor and central processing unit.

7. The method according to claim 1, wherein the second control device is selected from the group consisting of microcontroller, microprocessor and central processing unit.

8. The method according to claim 1, wherein the predetermined area comprises a first portion for storing the command and a second portion for storing data.

9. An operation method of a control device, comprising the steps of:
reading a command from a predetermined area in a storage unit outside the control device; and
executing the command.

10. The method according to claim 9, further comprising the step of erasing the predetermined area after the step of reading a command from a predetermined area.

11. The method according to claim 10, further comprising the step of writing an execution result into the predetermined area.

12. The method according to claim 9, further comprising the step of writing an execution result into a second area other than the predetermined area in the storage unit.

13. The method according to claim 11, further comprising the step of setting a flag for indicating the content of the predetermined area is the execution result or another command.

14. The method according to claim 9, wherein the control device is selected from the group consisting of microcontroller, microprocessor and central processing unit.

15. The method according to claim 9, wherein the predetermined area comprises a first portion for storing the command and a second portion for storing data.

16. An electronic device comprising:
a storage unit including a predetermined area;
a first control device for issuing a command and writing the command into the predetermined area; and
a second control device for reading the command from the predetermined area and executing the command.

17. The electronic device according to claim 16, wherein the first control device is selected from the group consisting of microcontroller, microprocessor and central processing unit.

18. The electronic device according to claim 16, wherein the second control device is selected from the group consisting of microcontroller, microprocessor and central processing unit.

19. The electronic device according to claim 16, wherein the storage unit is selected from the group consisting of DRAM, SRAM, EPROM, EEPROM and flash memory.

20. The electronic device according to claim 16, wherein the predetermined area comprises a first portion for storing the command and a second portion for storing data.
